(19) United States
(12) Patent Application Publication
(10) Pub. No.: US 2024/0214973 A1
(43) Pub. Date: Jun. 27, 2024

(54) METHODS, SYSTEMS, AND DEVICES FOR IDENTIFYING GEOLOCATIONS OF ACCESS POINTS IN WIRELESS NETWORKS

(71) Applicant: ARRIS Enterprises LLC, Horsham, PA (US)

(72) Inventors: Rajesh Pazhyannur, Fremont, CA (US); Matthew T. Melester, McKinney, TX (US)

(21) Appl. No.: 18/391,823

(22) Filed: Dec. 21, 2023

Related U.S. Application Data
(60) Provisional application No. 63/434,541, filed on Dec. 22, 2022.

(51) Int. Cl. H04W 64/00; H04W 12/037; H04W 16/14; H04W 84/12

(52) U.S. Cl. CPC H04W 64/003; H04W 12/037; H04W 16/14; H04W 84/12

(57) ABSTRACT

Methods, systems, and devices for selectively entering a standard power mode by an access point, using a geolocation obtained from a geolocation beacon. For example, an access point may be configured to provide wireless network service for a coverage area. The access point may include a processor configured to: attempt to obtain a signal transmitted wirelessly from a geolocation beacon comprising a geolocation; detect that the signal was not obtained from the geolocation beacon; obtain a geolocation from a controller configured to control at least some operations of the access point; provide the obtained geolocation to an Automated Frequency Coordination (AFC) server; receive approval from the AFC server to enter a standard power mode; and enter the standard power mode.

### CROSS-REFERENCE TO RELATED APPLICATION

The present application claims the benefit of priority to U.S. Provisional Application No. 63/434,541, filed on Dec. 22, 2022, and the entire contents of the above-identified application are incorporated by reference as if set forth herein.

### TECHNICAL FIELD

The present disclosure relates to wireless networks and access points thereof, and more specifically relates to methods, systems, and devices for identifying geolocations of access points in wireless networks.

### BACKGROUND

A wireless local area network (“WLAN”) refers to a network that operates in a limited area (e.g., within a home, school, store, campus, shopping mall, etc.) that interconnects two or more electronic devices using wireless radio frequency (“RF”) communications. Electronic devices belonging to users of a WLAN, such as smartphones, computers, tablets, printers, appliances, televisions, lab equipment and the like (herein “client devices”), can communicate with each other over the WLAN. Since wireless communications are used, the client devices can move throughout the area covered by the WLAN (e.g., as the users of the client devices move) and remain connected to the network. Most WLANs operate under a family of standards promulgated by the Institute of Electrical and Electronics Engineers (“IEEE”) that are referred to as the IEEE 802.11 standards. WLANs operating under the IEEE 802.11 family of standards are commonly referred to as WiFi networks. Client devices that include a networking subsystem that includes a WiFi network interface can communicate over WiFi networks.

A WiFi network includes one or more access points (APs, also referred to as hotspots) that are typically installed at fixed locations throughout the area covered by the WiFi network. The WiFi network can include a single AP that provides coverage in a very limited area or may include tens, hundreds or even thousands of access points that provide in-building and/or outdoor coverage to a large campus or region. Client devices communicate with each other and/or with wired devices that are connected to the WiFi network through the APs. The APs may be connected to each other and/or to one or more controllers through wired and/or wireless connections. The WiFi network typically includes one or more gateways that may be used to provide Internet access to the client devices.

Each AP of a WiFi network may communicate with client devices in a location serviced by the access point using wireless communication that is compatible with an IEEE 802.11 standard. The wireless communication may occur according to different IEEE standards in different frequency bands that are made available by regulatory agencies. For example, some frequencies between 2401-2473 MHz are available in North America for some WiFi communication (e.g., IEEE 802.11b/g/n/ax). The 2401-2473 MHz frequency range is often referred to as the “2.4 GHz frequency band.” Similarly, some frequencies between 5.150-5.895 GHz are also available for WiFi communication (e.g. IEEE 802.11a/h/j/n/ac/ax communication). The 5.150-5.895 frequency range is referred to as the “5 GHz frequency band.”

In an effort to provide increased spectrum for wireless communication use, the United States Federal Communications Commission (FCC) has recently made available frequencies in the range of 5.925-7.125 GHz available for use in IEEE 802.11ax and other WiFi communications. This frequency range is referred to as the “6 GHz frequency band.” Other countries are considering making, or have already made, some or all of the 6 GHz frequency band available for use to WiFi devices and networks. The relatively large size of the 6 GHZ frequency band may enable devices to use contiguous spectrum blocks, which may accommodate up to fourteen 80 MHz channels or seven 160 MHz channels. These wider channels may permit high-bandwidth applications, such as high-definition video streaming, cloud computing, and telepresence, as examples.

Prior to the FCC action, some individuals and organizations operated, and will continue to operate, fixed microwave links in the 6 GHz frequency band for, e.g., public utility control/management, emergency/police backhaul networks, cellular network backhaul, long distance telephone links, news gathering, or the like. Some television and radio uplinks for satellite service (e.g., “earth-to-space”) and some mobile satellite downlinks (e.g., “space-to-earth”) communication also occurs in the 6 GHz frequency band. Many of these already existing or incumbent users are licensed users, who have secured an exclusive right to transmit on an assigned frequency within a certain geographical area. One estimate is that there are over 50,000 licensed users of frequencies in the 6 GHz frequency band in the United States alone.

As part of the opening the 6 GHz frequency band for unlicensed use for WiFi communications, the FCC has promulgated requirements that are designed to protect these licensed incumbents from substantial interference by WiFi communications, which will be largely unlicensed. In greater detail, the 6 GHz frequency covers four separate sub-bands operating under unlicensed national information and infrastructure (U-NII) rules: U-NII-5, ranging from 5.925 GHz to 6.425 GHz; U-NII-6, ranging from 6.425 GHz to 6.525 GHz; U-NII-7, ranging from 6.525 GHz to 6.875 GHz; and U-NII-8, ranging from 6.875 to 7.125 GHz. The FCC has authorized all four sub-bands for indoor use by “low power” APs. Low power APs will be allowed to transmit indoors only with a maximum EIRP (Effective Isotropically Radiated Power) of 30 dBm (decibels per milliwatt), and client devices communicating with low power APs are limited to a maximum EIRP of 24 dBm. The FCC also requires that all low-power devices incorporate permanently attached integrated antennas to prevent the potential for users to replace an antenna of a device with a higher gain antenna and thereby generate interference.

In the U-NII-5 and U-NII-7 bands only, “standard-power” APs will be able to operate both indoors and outdoors. Standard power APs will be allowed to transmit indoors and outdoors with a maximum EIRP of 36 dBm, and client devices communicating with low power APs are limited to a maximum EIRP of 30 dBm. Such increased power will advantageously enable greater distances between the AP and the client device, particularly in outdoor implementations but also with use indoors.

However, the increased power also increases the potential for interference with the incumbent licensed users of the 6 GHz frequency band. The FCC has therefore issued rules requiring that APs capable of operating in standard power mode must consult an Automated Frequency Coordination (AFC) server to ensure non-interference prior to using the standard power levels. According to the FCC rules, when powering on, an AP must be capable of discovering its geolocation (such as the longitude, latitude and height above ground of the access point) automatically, and then report the geolocation and an uncertainty value to an AFC server. Based at least in part on the geolocation and uncertainty value, the AFC server may respond with a list of channels in the 6 GHz band of frequencies that the access point is permitted to use without causing interference issues to incumbent users in a vicinity or proximity to the AP. If the AP cannot ascertain its geolocation and/or does not receive a list of channels, then the AP may only operate in the low power mode.

### SUMMARY

According to some aspects of the present disclosure, a geolocation beacon is provided. The geolocation beacon may include a processor, a positioning signal reception system, and a wireless signal transmission system. The processor of the geolocation beacon may be configured to identify a geolocation of the geolocation beacon using positioning signals received by the positioning signal reception system and transmit the geolocation using the wireless signal transmission system.

According to some aspects of the present disclosure, an access point is provided, with the access point configured to provide wireless network service for a coverage area. The access point may be configured to attempt to obtain a geolocation signal transmitted wirelessly from a geolocation beacon. The access point may be configured to detect that the geolocation signal was not obtained from the geolocation beacon, and may be configured to obtain a geolocation from a controller that is configured to control at least some operations of the access point. The access point may be further configured to provide the obtained geolocation to an Automated Frequency Coordination (AFC) server. The access point may be configured to receive an approval from the AFC server to enter a standard power mode, and in response to the approval may enter the standard power mode.

According to some aspects of the present disclosure, an access point is provided, with the access configured to provide wireless network service for a coverage area. The access point may be configured to receive an access credential. The access point may be configured to obtain an encrypted geolocation signal transmitted wirelessly from a geolocation beacon. The access point may be configured to decrypt the encrypted geolocation signal and obtain a geolocation from the decrypted geolocation signal. The access point may be configured to provide the obtained geolocation to an Automated Frequency Coordination (AFC) server.

The present disclosure is not limited to the aspects recited in this summary section, and other aspects and embodiments of the inventive concepts provided herein may be obtained from the drawings and the detailed description thereof that follow.

### BRIEF DESCRIPTION OF THE DRAWINGS

FIG. 1 is a block diagram illustrating electronic devices and computer networking devices in a network according to some embodiments of the present disclosure.

FIGS. 2A and 2B are block diagrams illustrating examples of geolocation beacons according to some embodiments of the present disclosure.

FIGS. 3A, 3B, and 3C are diagrams illustrating examples of positioning of geolocation beacons within environments that includes access points, according to some embodiments of the present disclosure.

FIGS. 4A and 4B are a flow diagrams illustrating aspects of communicating geolocation information from a geolocation beacon to access points, according to some embodiments of the present disclosure.

FIG. 5 is a flow diagram illustrating aspects of receiving geolocation information at a first access point and communicating the same to a second access point via a controller, according to some embodiments of the present disclosure.

FIG. 6 is a flowchart illustrating some operations in a method of identifying a power mode to use in an access point, according to some embodiments of the present disclosure.

FIG. 7 is a flowchart illustrating some operations in a method of acquiring and transmitting a geolocation by a geolocation beacon, according to some embodiments of the present disclosure.

FIG. 8 is a flowchart illustrating some operations in a method of receiving and distributing a geolocation by a controller, according to some embodiments of the present disclosure.

FIGS. 9A, 9B, and 9C are diagrams illustrating examples of positioning of geolocation beacons within environments that includes access points, according to some embodiments of the present disclosure.

FIG. 10 is a flowchart illustrating some operations in a method of identifying a power mode to use in an access point, according to some embodiments of the present disclosure.

FIG. 11 is a block diagram illustrating an example of an electronic device according to some embodiments of the present disclosure.

Note that like reference numerals refer to corresponding parts throughout the drawings. Moreover, multiple instances of the same part are designated by a common prefix separated from an instance number by a dash.

### DETAILED DESCRIPTION

Providing each AP in a network with a geolocation positioning system receiver may be cost prohibitive, and in some instances (for example where the AP is installed indoors and outside a line of sight to a positioning system satellite) the AP may not be able to receive GPS or other positioning system signals to identify its geolocation.

Aspects of the present disclosure provide devices and communication techniques that may allow APs that do not include positioning system receivers to automatically determine a geolocation thereof. These capabilities may reduce the cost and complexity of the APs. In addition, the devices and communication techniques provided herein may enable APs to operate in standard power mode when indoors. For example, the methods, systems, and devices described herein may enable an AP to request approval from an AFC server (or other coordinating server) to operate in an unlicensed band of frequencies (such as a 6 GHz band of frequencies) when deployed indoors. Consequently, the communication techniques may enable use of the unlicensed band of frequencies, which may improve network communication performance.

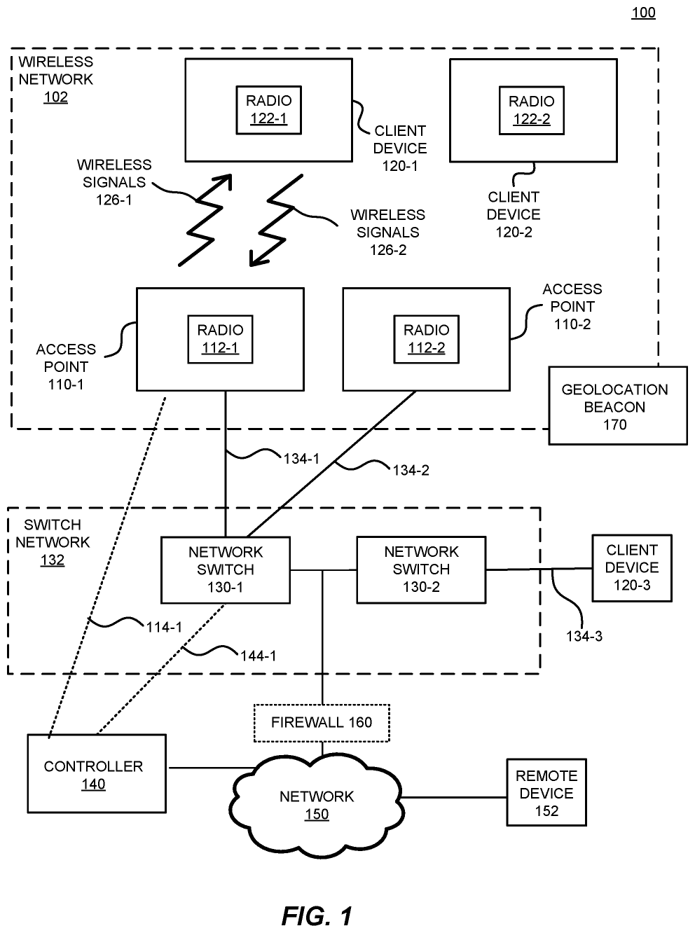

FIG. 1 is a block diagram illustrating electronic devices and computer networking devices in a network 100 according to some embodiments of the present disclosure. In the network 100, one or more access points 110 may communicate with client devices 120 in a wireless network 102, which may be a wireless local area network (WLAN). The access points 110 may be serviced by a switch network 132 that includes one or more network switches and/or routers 130, which may facilitate access to a network (e.g., an external network) 150. The network 100 may also include other computer networking devices (not shown) such as data planes or the like. The network 100 may also include one or more geolocation beacons 170.

The access points 110 may communicate using wireless and/or wired communication (such as by using Ethernet or a communication protocol that is compatible with Ethernet) with the client devices 120. Herein, wireless communication may include communication of packets or frames in accordance with a wireless communication protocol, such as an Institute of Electrical and Electronics Engineers (IEEE) 802.11 standard (sometimes referred to as ‘WiFi’. In the discussion that follows, WiFi is used as an illustrative example. For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Other wireless interfaces and/or protocols may be used, such as Bluetooth, and unless stated otherwise, the present disclosure is not limited to a particular wireless communication standard, interface, or protocol.

In some embodiments, the access points 110 may include physical access points and/or virtual access points that are implemented in software in an environment of an electronic device or a computer. In some embodiments, the access points 110 may communicate with each other via wired or wireless connections (e.g., via the switch network 132 or via wireless signals 126). The wired and/or wireless communication among access points 110 in wireless network 102 may occur via a network (such as an intra-net, a mesh network, point-to-point connections and/or the Internet) and may use a network communication protocol, such as Ethernet. In some embodiments, the access points 110 may be arranged in a mesh configuration, such as where a direct wired or wireless connection between an access point 110 and a network switch 130 of the switch network 132 is absent, and the access point 110 instead communicates indirectly with the switch network 132 and/or the network 150 via an intermediate access point 110.

As can be seen in FIG. 1, wireless signals 126-1 (represented by a jagged line) are transmitted from a radio 112-1 in access point 110-1. These wireless signals may be received by radio 122-1 in a client device 120-1. Wireless signals 126-2 (represented by a jagged line) are transmitted from the radio 122-1 in the client device 120-1. These wireless signals may be received by the radio 112-1 in the access point 110-1. Each of the radios 112 and 122 may be configured to generate and/or receive radio frequency signals in one or more wireless communication frequency bands (e.g., the 2.4 GHz frequency band, the 5 GHz frequency band, the 6 GHz frequency band, and so on). Although only one radio 112/122 is shown in each of the access points 110 and client devices 120, it may be understood that in some embodiments multiple radios 112/122 may be present, each configured to generate and/or receive signals in different frequency bands.

Each of the client devices 120 may be, for example, any network-capable electronic device, including (as non-limiting examples) a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device. As seen in FIG. 1, some client devices 120 (e.g., client device 120-3) may not be part of the wireless network 102, and may instead be directly coupled with a network switch 130 of the switch network 132.

The switch network 132 may include one or more network switches and/or routers 130. In some embodiments, the one or more network switches and/or routers 130 may include a stack of multiple switches or routers (which are sometimes referred to as ‘stacking units’). As an example, a network switch 130-1 may include a number of communication interfaces or ports (not shown) in communication with one or more electronic devices. During operation, a first of the communication interfaces may receive a packet or other data container from a first electronic device (e.g., a client device 120, an access point 110, another networking switch 130). The packet may then be processed and forwarded to a second port associated with a second electronic device. The network switch and/or router 130 may be a layer-2 or layer-3 network switch or router. The switch network 132, and the network switches 130 thereof, may be coupled to access points 110 of the wireless network 102 via wired links 134.

The controller 140 may be configured to perform configuration operations and/or management operations that control functionality of the access points 110 and network switches 130. For example, the controller 140 may define flow definitions comprising packet processing rules and corresponding actions and promulgate these rules to the network switches 130 of the switch network 132. As another example, the controller 140 may manage the access points 110, for example by providing various configuration information, controlling settings, routing information, authorization/authentication information, or the like. The controller 140 may communicate with the access point 110 and/or network switches 130 via one or more logical links 142, which in some embodiments may at least partially overlap the wired links 134. The controller 140 may be configured to offer a single user interface accessible via a web browser, command prompt, or the like, via which control commands may be entered.

In some embodiments, the controller 140 may be connected via physical links with one or more of the access points 110 or the network switches 130 (and may be part of the switch network 132). In some embodiments, the controller 140 may be one of the network switches 130. In some embodiments, the controller 140 may be a cloud-based controller 140 that may be operating at a location relatively remote from the switch network 132 and the network switches 130 thereof. The cloud-based controller 140 may communicate with the network switches 130 via a network 150. The controller 140 may be configured to receive commands from a remote device 152, which in some embodiments may be a laptop computer or other device similar to a client device 120 that is operated by a network administrator to perform configuration of the network 100. In some embodiments, more than one controller 140 may be present in the network 100. In some embodiments, the network switches 130 may be at locations relatively remote from one another, and may communicate with each other via a network, such as the network 150.

The network 150 may be a layer-2 or layer-3 network, and may include one or more local area networks (LANs), campus area networks (CANs), wide area networks (WANs), metropolitan area networks (MANs), and/or the Internet. The network 150 may be separated from the switch network 132 by a firewall 160, which may monitor network traffic that is incoming to and outgoing from the switch network 132 and decide whether to permit or prohibit various traffic based on one or more security rules.

The geolocation beacon 170 may be configured to receive geolocation positioning signals from a geolocation positioning system, and may be configured to broadcast or transmit wireless signals that include a geolocation identified from the geolocation positioning signals. The access points 110 may be configured to receive the wireless signals transmitted from the geolocation beacon 170, obtain the geolocation therefrom, and provide the geolocation to an AFC server as part of powering on of the access point or as part of entering a standard power mode.

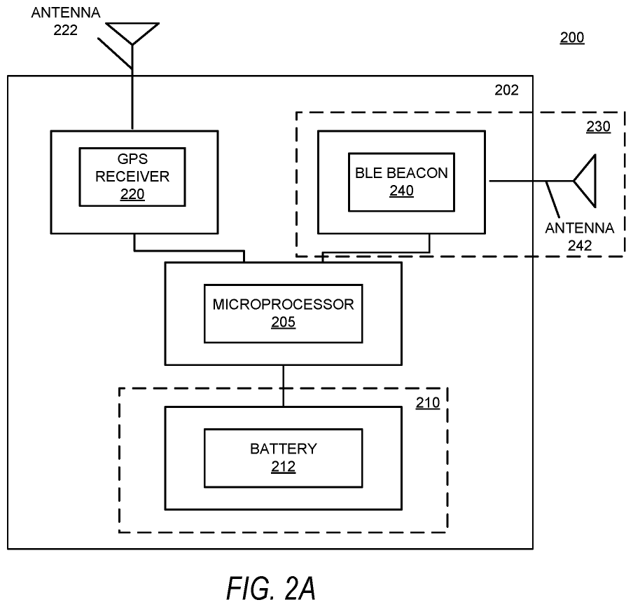

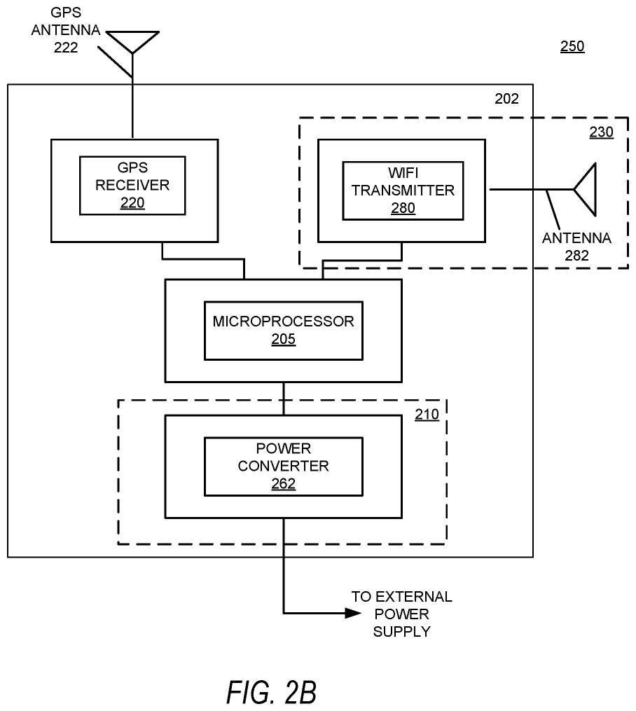

FIGS. 2A and 2B are block diagrams illustrating examples of geolocation beacons 200 and 250 according to some embodiments of the present disclosure, which may be used as the geolocation beacon 170 of FIG. 1.

Referring now to FIGS. 2A and 2B, a geolocation beacon 200/250 may include a housing 202, which may be affixable to a surface (not shown) such as a window or wall. The housing 202 may include therein a power source 210, such as a battery 212 (FIG. 2A) or power converter 262 (FIG. 2B). The power source 210 may be coupled to a microprocessor 205. The geolocation beacon 200/250 may also include a positioning system receiver 220 coupled to a positioning system antenna 222, and a wireless signal transmission system 230. The positioning system receiver 220 and/or wireless signal transmission system 230 may also be coupled to the power source 210. In some embodiments, the power source 210 may be or may include an internal (non-accessible) battery or an external battery, and which in some embodiments may be rechargeable.

The positioning system receiver 220 and positioning system antenna 222 may be configured to receive positioning system signals from one or more global navigation satellite systems (GNSS), such as the Global Positioning System (GPS), GLONASS, Galileo, BDS, and so on. In some aspects, the positioning system receiver 220 and positioning system antenna 222 may be configured to receive positioning system signals from regional navigation satellite systems, such as NAVIC or QZSS. The positioning system receiver 220 may then use the received positioning system signals to identify a geolocation of the geolocation beacon 200/250. For example, the positioning system receiver 220 may be programmed to identify a latitude, longitude, and altitude or height (as non-limiting examples) from a plurality of positioning system signals received at the positioning system receiver 220, and derive a geolocation from the identified latitude, longitude, and altitude or height (as non-limiting examples). In some embodiments, the geolocation may include or may be associated with an uncertainty value (e.g., the identified geolocation is accurate to within 5 meters). In some embodiments, the positioning system receiver 220 may provide the received positioning system signals to the microcontroller 205 and the microcontroller 205 may be programmed to itself identify the geolocation (e.g., a latitude, longitude, altitude or height, uncertainty) from a plurality of positioning system signals received via the positioning system receiver 220.

The microcontroller 205 may receive the identified geolocation (or the received positioning system signals) and provide the identified geolocation to the wireless signal transmission system 230. In some embodiments, as discussed further below, the microcontroller 205 may encrypt the identified geolocation using an encryption key or encryption credential prior to providing the geolocation to the wireless signal transmitter 230. The microcontroller 205 may establish a communication session between the geolocation beacon 200/250 and the access point 110.

As seen in FIG. 2A, in some embodiments the wireless signal transmission system 230 may be or include a Bluetooth Low Energy (BLE) beacon 240 and Bluetooth-enabled antenna 242, which may periodically transmit Bluetooth signals that include the identified geolocation. In some embodiments, the packets transmitted by the BLE beacon 240 (via the Bluetooth-enabled antenna 242) may include a transmission power, which may be used by the access point 110 in calculating a distance from the geolocation beacon 200 using a received signal strength indicator (RSSI) distance formula.

As seen in FIG. 2B, in some embodiments the wireless signal transmission system 230 may be or include a WiFi signal transmitter 280 and WiFi-enabled antenna 282. The WiFi signal transmitter 280 may periodically transmit WiFi signals that include the identified geolocation and include information from the microcontroller 205 for identification by the access point 110 as geolocation-containing WiFi signals. For example, the WiFi signals may be specially-formatted, marked, or tagged for identification by the access point 110. In some embodiments, the packets transmitted by the WiFi signal transmitter 280 (via the WiFi-enabled antenna 282) may include a transmission power, which may be used by the access point 110 in calculating a distance from the geolocation beacon 250 using a received signal strength indicator (RSSI) distance formula.

A WiFi signal transmitter may provide a WiFi signal having increased energy or signal power as compared with the BLE beacon 240 of FIG. 2A, thus increasing a range or distance between the geolocation beacon 250 and the access point 110, at the expense of the geolocation beacon 250 having increased power consumption requirements that are serviced by the power converter 262.

In some embodiments, a geolocation beacon may be provided with other wireless signal transmitters 230 that are configured to transmit (and, in some embodiments receive) signals in one or more of a variety of protocols or formats, at one or more different frequencies, and so on. In some embodiments, a geolocation beacon (wireless signal transmission system 230 thereof) may include both a WiFi transmitter 280 and a BLE beacon 240, and one or more antennas operable in frequency ranges to communicate signals from the WiFi transmitter 280 and BLE beacon 240.

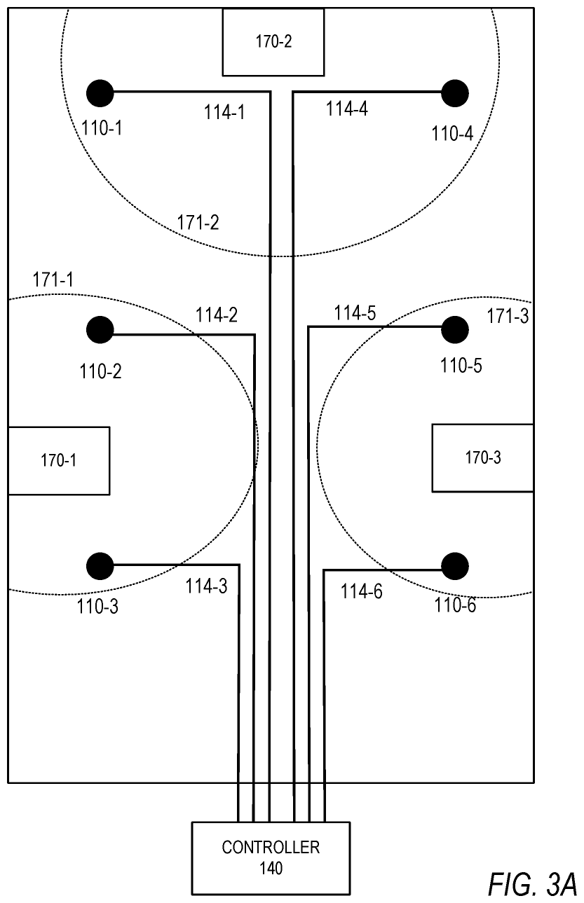

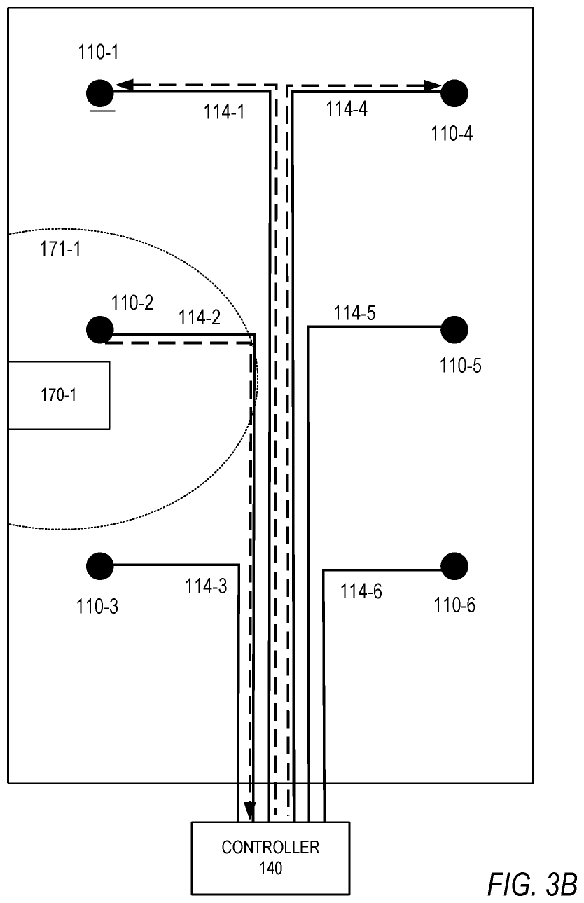

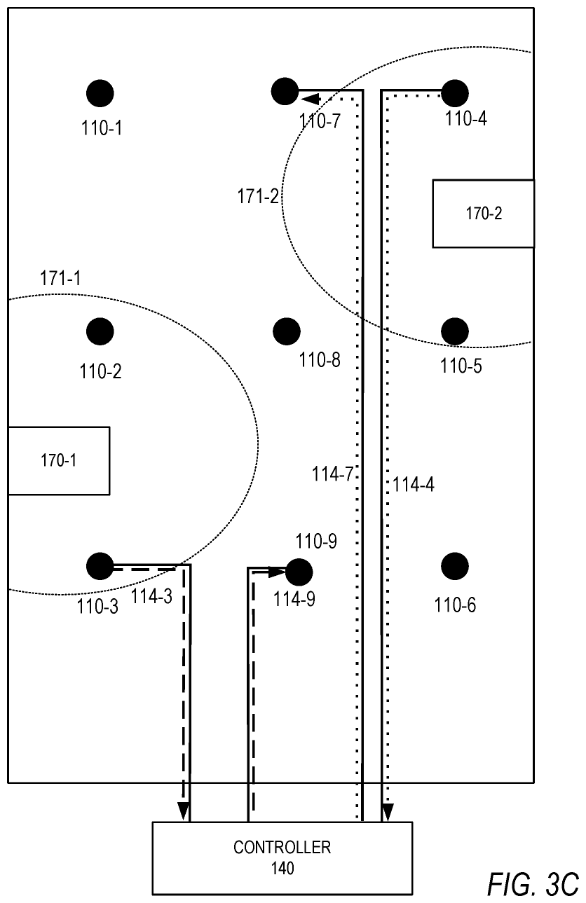

FIGS. 3A, 3B, and 3C are diagrams illustrating examples of positioning of geolocation beacons 170 within environments that includes access points 110, according to some embodiments of the present disclosure. As seen in FIG. 3A, in some embodiments, geolocation beacons 170 may be provided along exterior walls of an installation environment 300 so as to provide coverage for access points 110 in the installation environment 300. Although one result of the positioning of geolocation beacons 170 relative to access points 110 shown in FIG. 3A is that each access point 110 is within a communication range 171 of a geolocation beacon 170, the positioning of FIG. 3A may not be practical in many situations, as many of the access points 110 may not be located within a distance of the exterior wall or window of the installation environment 300 so as to be in range of the geolocation beacons 170. The positioning of FIG. 3A may also result in increased expense, as multiple geolocation beacons 170 may be required.

Accordingly, and pursuant to some embodiments of the present inventive concepts, a first access point 110-1 may provide a geolocation obtained from a geolocation beacon to a second access point 110-2. The geolocation may be provided to the second access point 110-2 via the controller 140 (or directly from the first access-point 110-1 to the second access point 110-2 if the access points 110 are in communication with each other).

FIG. 3B illustrates an example in which at least one access point (e.g., a second access point 110-2) are within a communication range 171-1 of a geolocation beacon 170-1, but other access points (e.g., a first access point 110-1 or a fourth access point 110-4) are not within the communication range 171-1. Systems and methods of the present disclosure may provide that the second access point 110-2 may provide obtained geolocation to the controller 140 (e.g., via a logical link 114-3). The controller 140 may then provide the geolocation to the first access point 110-1 or other access points, such that the other access points 110 may then consult the Automated Frequency Coordination (AFC) server as part of entering a standard power mode using the geolocation obtained by the second access point 110-2.

As another example, FIG. 3C illustrates an example in which at least one access point (e.g., a second access point 110-2) is within a first communication range 171-1 of a first geolocation beacon 170-1 and at least one access point (e.g., a fourth access point 110-4) is within a second communication range 171-2 of a second geolocation beacon 170-2, but other access points (e.g., a seventh access point 110-7 or a ninth access point 110-9) are not within a communication range 171 of any geolocation beacon 170. Systems and methods of the present disclosure may provide that each access point 110 within a communication range 171 of a geolocation beacon 170 may provide an obtained geolocation to the controller 140 (e.g., via a respective logical link 114). In the example of FIG. 3C, the controller may then receive multiple geolocations (e.g., multiple geolocations from multiple different geolocation beacons). The controller 140 may then provide a selected geolocation instance to access points 110 requesting geolocations from the controller 140, such that the other access points 110 may then consult the Automated Frequency Coordination (AFC) server as part of entering a standard power mode using the geolocation obtained by an access point 110 in a communication range 171 of a geolocation beacon 170. In some embodiments, the controller 140 may select a geolocation instance that is received from a neighbor access point 110 that is nearest to the requesting access point 110. In some embodiments, the controller 140 may select a geolocation instance received from an access point 110 that has the highest degree of certainty (e.g., is indicated to be a most accurate geolocation instance).

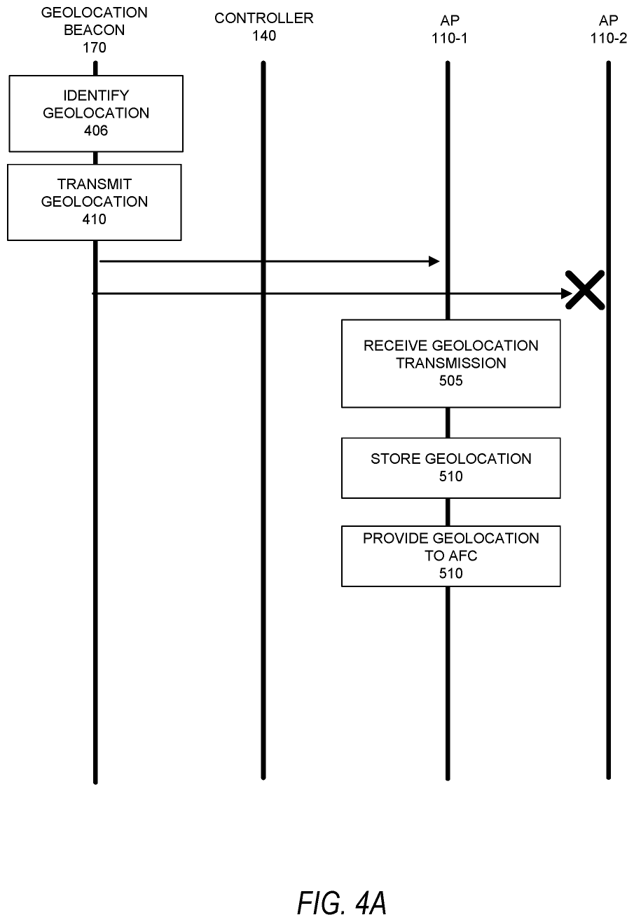

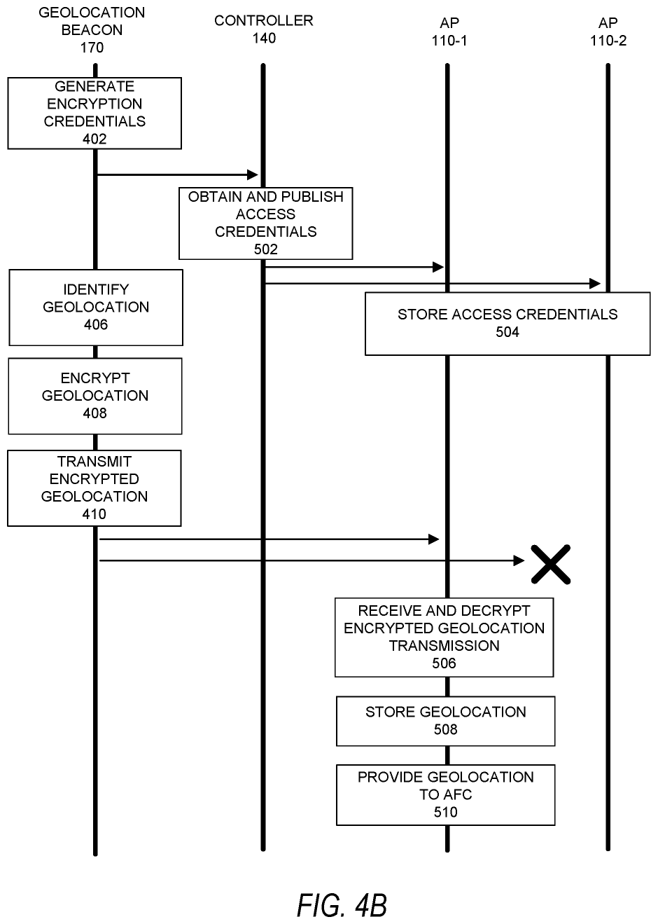

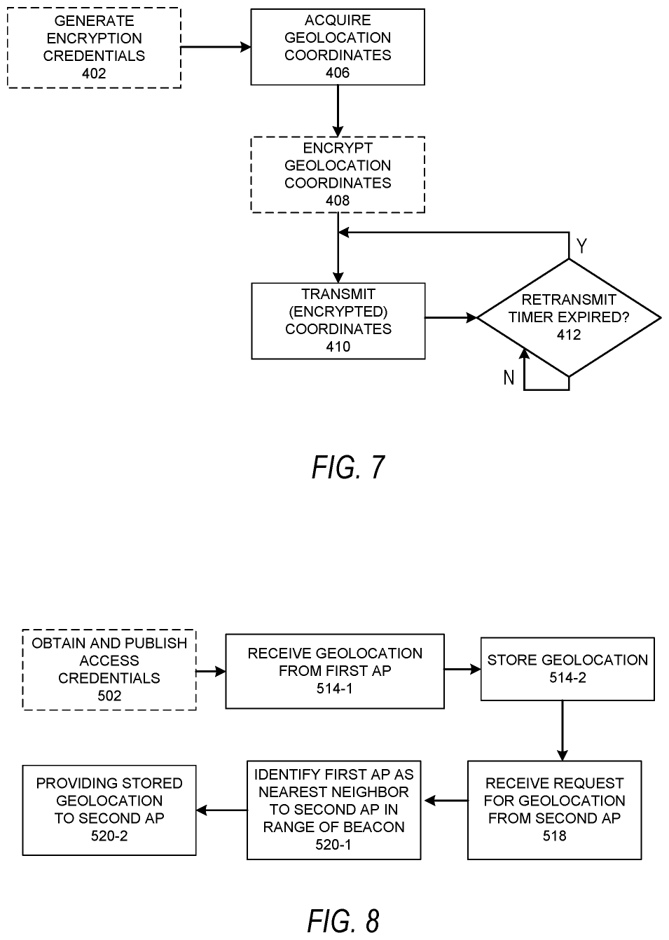

FIGS. 4A and 4B are a flow diagrams illustrating aspects of communicating geolocation information from a geolocation beacon 170 to access points 110, according to some embodiments of the present disclosure. FIG. 7 is a flowchart illustrating some operations in a method of acquiring and transmitting of a geolocation by a geolocation beacon 170, according to some embodiments of the present disclosure. Referring to FIG. 4A and 7, a geolocation beacon 170 may acquire positioning system signals using the geolocation positioning system receiver 220 and geolocation positioning system antenna 222, and then use the positioning system signals to identify a geolocation of the geolocation beacon 170 (operation 406 of FIG. 4A and 7). The identified geolocation may be transmitted, for example using a specific transmission format or packet (operation 410 of FIG. 4A and 7). In some embodiments, the geolocation may be provided as a latitude, longitude, and altitude (or height from ground or sea level). The transmission of the geolocation may include transmission of an uncertainty value associated with the geolocation.

In some embodiments, a security mechanism may be used to secure or encrypt the geolocation that is transmitted from the geolocation beacon 170 and received by the access points 110. The usage of a security mechanism may ensure that an access point 110 does not receive an improper or incorrect geolocation (e.g., from an unintended or malicious source of geolocation data). Referring to FIG. 4B and 7, a geolocation beacon 170 may be instructed to generate encryption credentials, such as a public and private key pair, passphrase, or other encryption credentials (operation 402 of FIG. 4B and 7). As discussed in detail below, the geolocation beacon 170 may transmit a portion of the encryption credentials (e.g., the public key) to a controller 140, which may be configured to receive (or obtain) and then disseminate or publish the received encryption credentials to the access points 110 for use in decrypting encrypted communications that are transmitted by the geolocation beacon 170 (operation 502 of FIG. 4B). The access points 110 may be configured to receive and then store the encryption credentials received (or obtained) from the controller 140 for use in decrypting encrypted communications that are transmitted by the geolocation beacon 170 (operation 504 of FIG. 4B).

The geolocation beacon 170 may acquire positioning system signals using the geolocation positioning system receiver 220 and geolocation positioning system antenna 222, and then use the positioning system signals to identify a geolocation of the geolocation beacon 170 (operation 406 of FIG. 4B and 7). In some embodiments, the geolocation may be stored as coordinates, such as latitude, longitude, and altitude (or height from ground or sea level). In some embodiments, the geolocation may include or be associated with an uncertainty value. The geolocation may be encrypted using a portion of the encryption credentials (e.g., the private key), resulting in an encrypted geolocation (operation 408 of FIG. 4B and 7). The encrypted geolocation may be transmitted using the wireless signal transmission system 230 of the geolocation beacon 170 (operation 410 of FIG. 4B and 7).

In some embodiments, and regardless of whether the encryption scheme discussed above is used, the geolocation beacon (e.g., microcontroller 205 thereof) may be configured to instantiate a retransmit timer, and identify an expiration of the retransmit timer (operation 412 of FIG. 7). When the retransmit timer expires (“Y” branch of operation 412 of FIG. 7), the geolocation beacon 170 may be configured to retransmit the acquired geolocation. Otherwise, (“N” branch of operation 412 of FIG. 7) the geolocation beacon 170 may refrain from retransmission of the geolocation.

In some embodiments, and regardless of whether the encryption scheme discussed above is used, the geolocation beacon (e.g., microcontroller 205 thereof) may be configured to instantiate a refresh timer, which may be implemented separately from the retransmit timer discussed above. The geolocation beacon may identify an expiration of the refresh timer. When the refresh timer expires, the geolocation beacon 170 may be configured to acquire new positioning system signals and identify a (potentially new) geolocation of the geolocation beacon 170. The geolocation beacon 170 may then begin to broadcast or transmit a new geolocation that is corresponding to the new positioning system signals. Prior to expiration of the refresh timer, the geolocation beacon 170 may refrain from reacquisition of positioning system signals. The use of the refresh timer may be helpful in situations in which the geolocation beacon 170 is moved throughout an environment (e.g., so that access points 110 may receive the wireless signals transmitted by the geolocation beacon 170).

As can be seen in FIGS. 4A and 4B, an access point 110 (e.g., a first access point 110-1) may receive a wireless transmission including an identified geolocation from the geolocation beacon 170, which may be unencrypted (operation 505 of FIG. 4A) or encrypted (operation 506 of FIG. 4B). When an encryption scheme is used, the access point 110 may then decrypt the encrypted geolocation data using the stored encryption credentials (operation 506 of FIG. 4B). The access point 110 may store the provided geolocation (operation 508 of FIGS. 4A and 4B), and provide the geolocation to an AFC server (operation 510 of FIGS. 4A and 4B).

In some embodiments, prior to providing the geolocation to the AFC server, the access point 110 may attempt to calculate an offset distance between the geolocation beacon 170 and the access point 110. As a non-limiting example, the offset distance may be calculated using a difference between the transmission power of the signal transmitted by the geolocation beacon 170 and a signal strength of the signal received by the access point 110. The uncertainty value transmitted to the AFC server by the access point 110 may include a sum of the uncertainty value generated or calculated (and transmitted) by the geolocation beacon 170, and the offset distance between the geolocation beacon 170 and the access point 110 that is calculated by the access point 110.

As discussed above, at least in part on the geolocation and uncertainty value, the AFC server may respond with a list of channels in the 6 GHz band of frequencies that the access point 110 is permitted to use without causing interference issues to incumbent users in a vicinity or proximity to the access point 110.

However, as can be seen in FIGS. 4A and 4B, and with reference to the discussion of FIGS. 3A-3C above, in some embodiments and situations, not all access points 110 may be within a communication range 171 of the geolocation beacon 170, and thus not all access points 110 may receive the wireless signals transmitted by the geolocation beacon 170. For example, in FIGS. 4A and 4B, a first access point 110-1 may receive the wireless signals transmitted by the geolocation beacon 170, while a second access point 110-2 may not receive the wireless signals transmitted by the geolocation beacon 170.

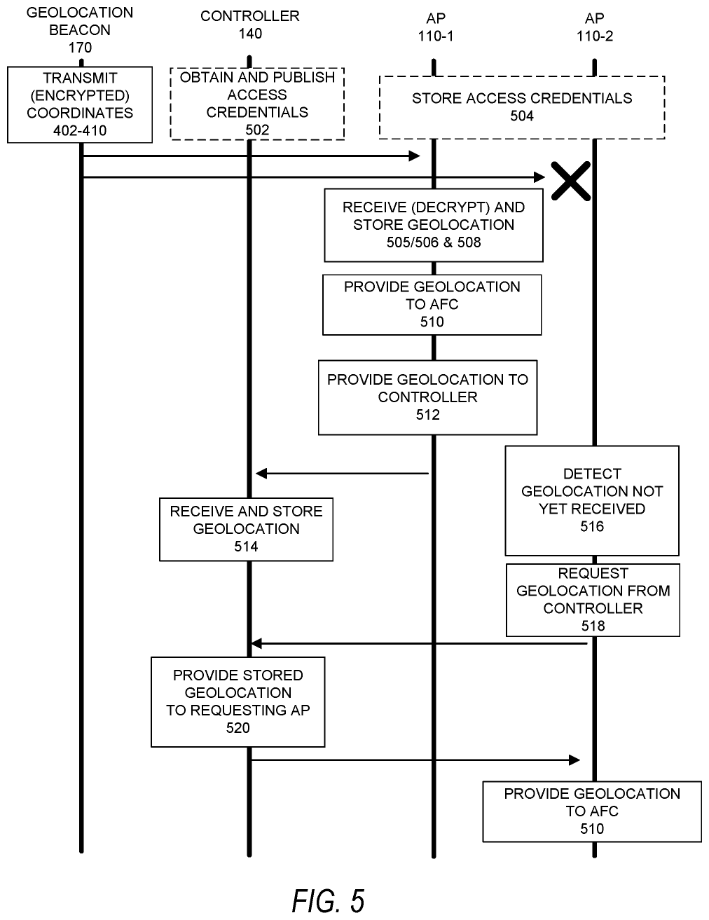

FIG. 5 is a flow diagram illustrating aspects of receiving geolocation information at a first access point and communicating the same to a second access point via a controller according to some embodiments of the present disclosure. FIG. 5 illustrates the transmission of the geolocation from the geolocation beacon 170 discussed in operations 402-410 of FIGS. 4A, 4B, and 7, and FIG. 5 also illustrates the optional obtaining and transmission of encryption access credentials by the controller 140 and the storage of the same by the access points 110 in operations 502 and 504 discussed above.

In addition to the first access point 110-1 providing the geolocation to the AFC server, the first access point 110-1 may also provide the geolocation to the controller 140 (operation 512). In some embodiments where the encryption mechanism discussed above is used, the first access point 110-1 may provide the decrypted geolocation, while in some embodiments the first access point 110-1 may provide the geolocation as an encrypted geolocation.

The controller 140 may receive and store a geolocation from a first access point 110-1 (operation 514). For example, the controller 140 may store the received geolocation in a memory, and may associate the stored geolocation with the first access point 110-1.

During an initialization or powering on of the second access point 110-2, the second access point 110-2 may detect that it has not received a wireless signal that includes a geolocation from a geolocation beacon 170 (operation 516). The second access point 110-2 may then request a geolocation from the controller 140 (operation 518). The controller 140 may identify and transmit a geolocation stored by the controller 140 to the second access point 110-2 (operation 520). The second access point 110-2 may then provide the geolocation to an AFC server (operation 510).

As discussed above, when an access point reports its geolocation to an AFC server, it must also provide an uncertainty value to the AFC server. Accordingly, in some embodiments, prior to providing the geolocation to the AFC server, the second access point 110-2 may attempt to calculate an offset distance between the first access point 110-1 and the second access point 110-2. As a non-limiting example, the offset distance may be calculated using a precoded or hard-coded distance between the first and second access points 110-1 and 110-2. As another example, the second access point 110-2 may use various network characteristics or parameters to identify an approximate distance between the first and second access points 110-1 and 110-2. The uncertainty value transmitted to the AFC server by the access point 110 may include a sum of the uncertainty value generated or calculated (and transmitted) by the geolocation beacon 170, a first offset distance between the geolocation beacon 170 and the first access point 110-1 that is calculated by the first access point 110-1, and a second offset distance between the first access point 110-1 and the second access point 110-2 that is calculated by the second access point 110-2.

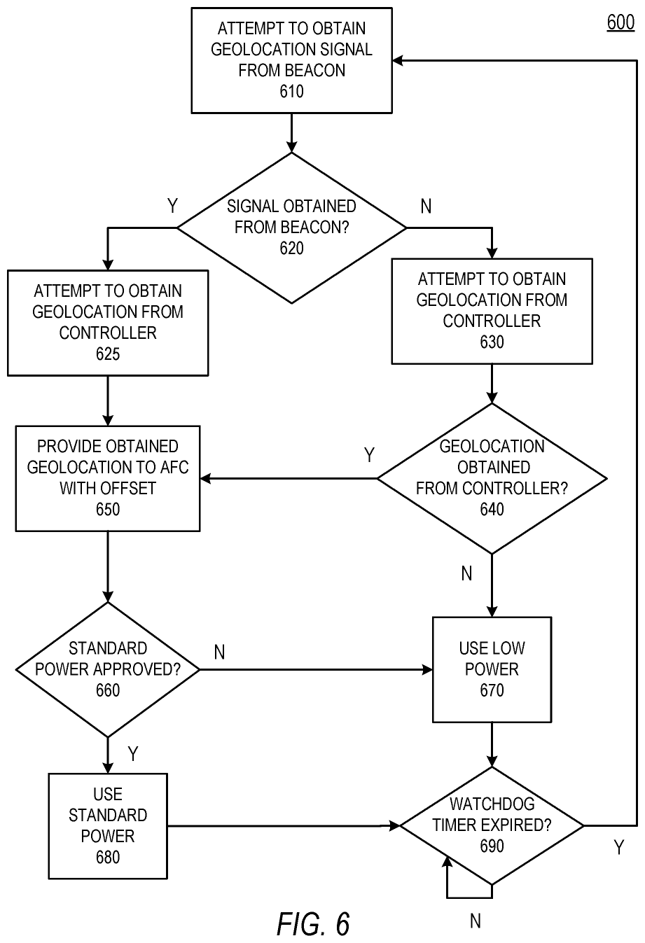

FIG. 6 is a flowchart illustrating some operations in a method 600 of identifying a power mode to use in an access point 110, according to some embodiments of the present disclosure. Reference is made to FIGS. 4A, 4B, and 5. The method 600 may begin (e.g., may be executed or performed by a process of an access point 110) at an initiation, start-up, or power-on state of the access point 110.

The access point 110 may attempt to obtain a geolocation from a geolocation beacon (operation 610). For example, the access point 110 may listen (using a Bluetooth-enabled receiver and/or WiFi antenna) for a wireless signal transmitted from a geolocation beacon. The access point may attempt to obtain the geolocation from the geolocation beacon for a period of time and/or for a number of attempts that may be selectable. Although increasing the number of attempts or a length of time to try and obtain a signal from the geolocation beacon 170 may improve a likelihood that the access point 110 does in fact receive such a wireless signal from the geolocation beacon 170, the access point 110 may not be able to service clients thereof (e.g., client devices 120 of FIG. 1) while attempting to obtain the geolocation from the geolocation beacon 170, and thus a time or number of attempts may be selected to balance various factors.

The access point 110 may then identify or determine whether a wireless signal was obtained from a geolocation beacon (operation 620). If a wireless signal was received (“Y” branch from operation 620), then the access point 110 may obtain a geolocation from the wireless signal (operation 625) and provide the obtained geolocation to the AFC (operation 650). The obtaining of the geolocation from the geolocation beacon 170 may include the operations 505 or 506 and 508 discussed above, or operations similar to those previously discussed, and duplicate description thereof is omitted here in favor of the previously-provided description. The providing of the obtained geolocation to the AFC server may include operation 510 discussed above, and may also include the calculating and providing of the offset distance discussed previously.

If a wireless signal was not received from the geolocation beacon (“N” branch from operation 620), then the access point 110 may attempt to obtain a geolocation from the controller 140 (operation 630). The attempting to obtain the geolocation from the controller 140 may include the operations 516 and 518 discussed above, or operations similar to those previously discussed, and duplicate description thereof is omitted here in favor of the previously-provided description. If a geolocation was received from the controller 140 (“Y” branch from operation 640), then the access point 110 provides the obtained geolocation to the AFC (operation 650), which may include the calculating and providing of the offset distance discussed previously.

Subsequent to a geolocation being provided to the AFC server, the AFC server may respond with either an approval or a non-approval to use standard power mode, and the access point 110 may examine the response from the AFC server (operation 660). If the AFC server approves the use of the standard power mode (“Y” branch from operation 660), then the access point 110 may enter the standard power mode (operation 680). On the other hand, if the AFC server does not approve the use of the standard power mode (“N” branch from operation 660), then the access point 110 may enter a low power mode (operation 670). The access point may also enter the low power mode if it is unable to receive a geolocation from the controller 140 (“N” branch from operation 640).

In some embodiments, the access point 110 may be configured to instantiate a watchdog timer, and identify an expiration of the watchdog timer (operation 690). When the watchdog timer expires (“Y” branch of operation 690), the access point 110 may be configured to begin the process of FIG. 6 and attempt to obtain a new geolocation from a geolocation beacon 170 or a controller 140. Otherwise, (“N” branch of operation 690 of FIG. 6) the access point 110 may refrain from attempting to acquire a new geolocation. In some embodiments, the access point 110 may instantiate the watchdog timer and attempt to obtain new geolocation only when operating in the low power mode. In some embodiments, the access point 110 may instantiate the watchdog timer having a first duration when operating in the low power mode, and having a second duration when operating in the standard power mode. The first duration may be shorter than the second duration.

FIG. 8 is a flowchart illustrating some operations in a method of receiving and distributing a geolocation by a controller 140 , according to some embodiments of the present disclosure. In some embodiments, a geolocation beacon 170 may transmit a portion of the encryption credentials (e.g., a public key) to a controller 140, which may be configured to receive (or obtain) and then disseminate or publish the received encryption credentials to the access points 110 for use in decrypting encrypted communications that are transmitted by the geolocation beacon 170 (operation 502). Subsequently, the controller 140 may receive a geolocation from a first access point 110-1 (operation 512-1). The controller 140 may store the received geolocation in a memory, and may associate the stored geolocation with the first access point 110-1 (operation 512-2). The controller 140 may receive a request from a second access point 110-2, which has detected that it has not received a wireless signal that includes a geolocation from a geolocation beacon 170 (operation 518).

The controller 140 may identify the first access point 110-1 as a nearest neighbor of access point 110-2 that is in range of a geolocation beacon 170 (operation 520-1). For example, the controller 140 may be aware of a layout of the access points 110-1 and 110-2 in relation to each other, either physically and/or having coverage areas that are nearest to each other. The controller 140 may be aware of handoffs or reassociations of client devices 120 that move from the first access point 110-1 to the second access point 110-2. In some embodiments, the first access point 110-1 may provide to the controller 140 a list of access points 110 that are known nearest neighbors to the first access point 110-1, and the controller 140 may compare the list with the stored geolocations and associated access points 110. The controller 140 may identify and transmit a geolocation (which may be encrypted or unencrypted) that is stored by the controller 140 to the second access point 110-2 (operation 520-2).

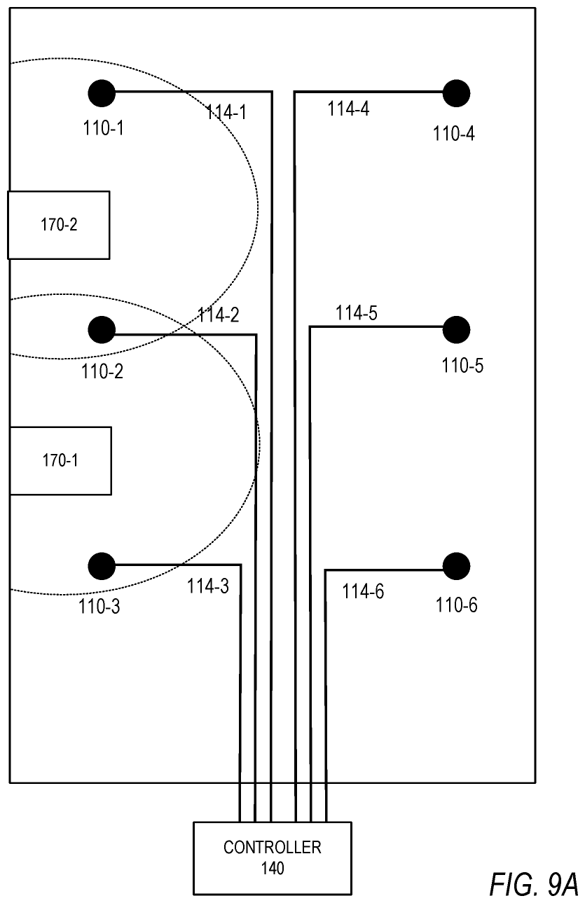

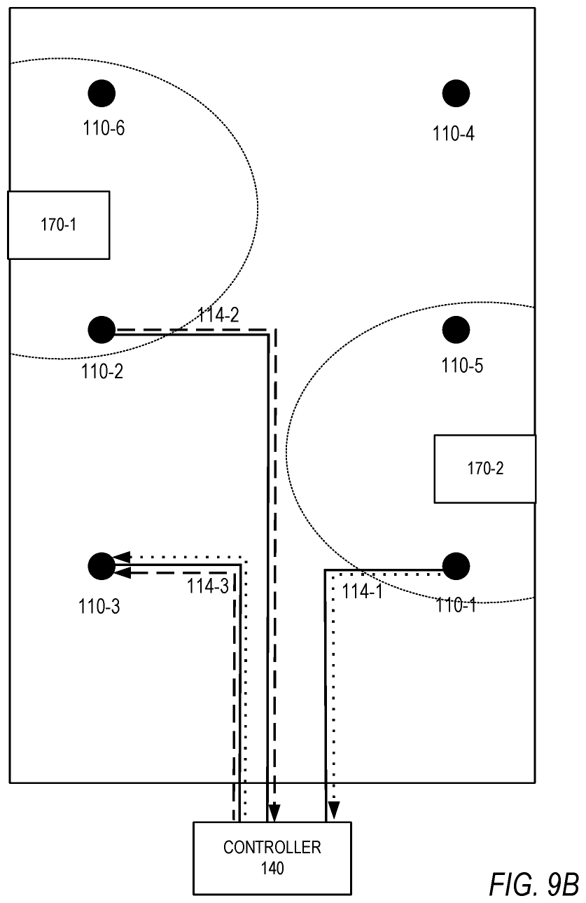

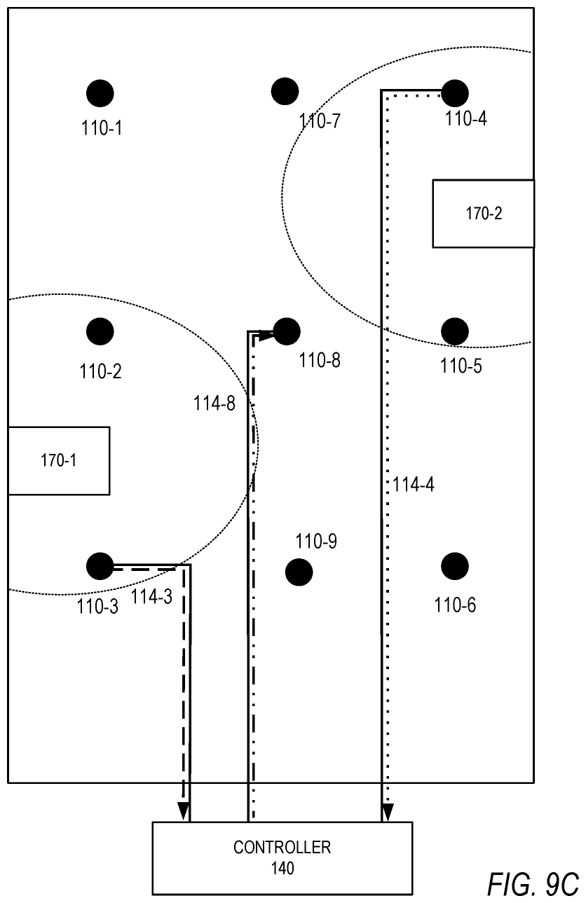

In addition to the example environments and layouts provided above with respect to FIGS. 3A-3C, other example environments and layouts are considered herein in which signals from a first and second geolocation beacon 170 may be used to identify a geolocation of an access point 110 with increased resolution or certainty. FIGS. 9A-9C are diagrams illustrating examples of positioning of geolocation beacons within environments that includes access points, according to some embodiments of the present disclosure. As can be seen in FIG. 9A, in some embodiments, an access point 110 (such as a second access point 110-2) may be within a communication range 171-1 of a first geolocation beacon 170-1, and also within a communication range 171-2 of a second geolocation beacon 170-2. The access point 110-2 may receive a first geolocation from the first geolocation beacon 170-1, and may also receive a second geolocation from the second geolocation beacon 170-2. In some embodiments, an access point 110 may be configured to select one of the first geolocation or the second geolocation (e.g., select from among the first geolocation and the second geolocation a geolocation having a higher certainty value or lower uncertainty value). In some embodiments, the access point 110-2 may generate a derived geolocation using the first and second geolocation. For example, the access point 110-2 may calculate an intersectional area formed from an intersection between a first area centered about the first geolocation (and having a radius based on the uncertainty value of the first geolocation), and a second area centered about the second geolocation (and having a radius based on the uncertainty value of the second geolocation). The access point 110-2 may calculate a geolocation at an approximate center point of the intersectional area as the derived geolocation.

As another example, as can be seen in FIG. 9B, in some embodiments, a third access point 110-3 may receive a first geolocation (or a portion of a first geolocation) received by a first access point 110-1 from a first geolocation beacon 170-1, and also receive a second geolocation (or a portion of a second geolocation) received by a second access point 110-2 from a second geolocation beacon 170-2. The third access point 110-3 may use the first and second geolocation to calculate or determine an approximate geolocation of the third access point 110-3.

As another example, as can be seen in FIG. 9C, in some embodiments, a third access point 110-3 may receive a calculated geolocation from the controller that is based on a first geolocation received by a first access point 110-1 from a first geolocation beacon 170-1, and also based a second geolocation (or a portion of a second geolocation) received by a second access point 110-2 from a second geolocation beacon 170-2. Accordingly, in some embodiments, the geolocation received by the third access point 110-3 may differ from the first geolocation received by the first access point 110-1 from the first geolocation beacon 170-1 and the second geolocation received by the second access point 110-2 from the second geolocation beacon 170-2.

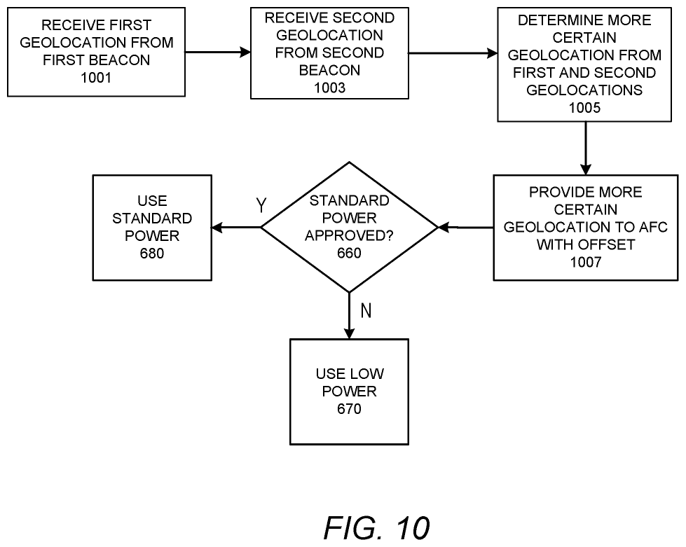

FIG. 10 is a flowchart illustrating some operations in a method of identifying a power mode to use in an access point 110, according to some embodiments of the present disclosure. The access point 110 may receive a first geolocation from a first geolocation beacon (operation 1001). For example, the access point 110 may listen (using a Bluetooth-enabled receiver and/or WiFi antenna) for a wireless signal transmitted from a geolocation beacon 170. The access point 110 may attempt to obtain the geolocation from the geolocation beacon for a period of time and/or for a number of attempts that may be selectable, as discussed above. The access point 110 may also receive a second geolocation from a second geolocation beacon (operation 1003).

Using the first and second geolocations, the access point 110 may determine a more certain geolocation from the first and second geolocations (operation 1005). As discussed above, in some embodiments, this may include selecting between the first and second geolocations, or calculating or generating a derived geolocation from the first and second geolocations.

The access point may provide the more certain geolocation being provided to the AFC server (with an offset value as discussed above) (operation 1007), and the AFC server may respond with either an approval or a non-approval to use standard power mode. The access point 110 may examine the response from the AFC server (operation 660). If the AFC server approves the use of the standard power mode (“Y” branch from operation 660), then the access point 110 may enter the standard power mode (operation 680). On the other hand, if the AFC server does not approve the use of the standard power mode (“N” branch from operation 660), then the access point 110 may enter a low power mode (operation 670).

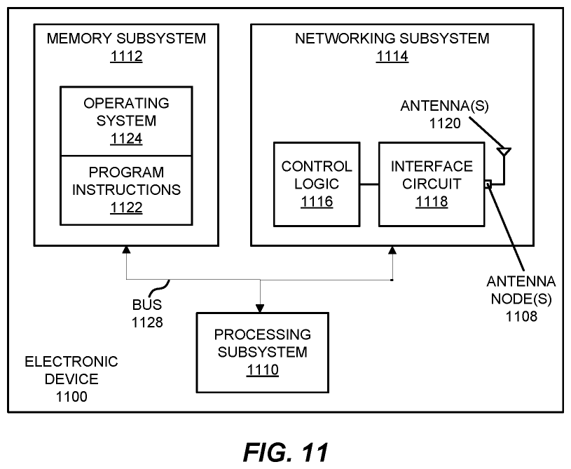

FIG. 11 is a block diagram illustrating an electronic device 1100 in accordance with some embodiments. The electronic device 1100 may be, for example, one of the access points 110 or one of the client devices 120 illustrated in FIG. 1, the network switches 130 illustrated in FIG. 1, the controller 140 of FIG. 1, the geolocation beacon 170 of FIG. 1, and other electronic devices described herein. The electronic device 1100 includes a processing subsystem 1110, a memory subsystem 1112, and a networking subsystem 1114. Processing subsystem 1110 includes one or more devices configured to perform computational operations. Memory subsystem 1112 includes one or more devices for storing data and/or instructions. In some embodiments, the instructions may include an operating system and one or more program modules which may be executed by processing subsystem 1110.

Networking subsystem 1114 includes one or more devices configured to couple to and communicate on a wired and/or wireless network (i.e., to perform network operations), including: control logic 1116, an interface circuit 1118 and one or more antennas 1120 (or antenna elements). While FIG. 11 includes an antenna 1120, in some embodiments electronic device 1100 includes one or more nodes, such as nodes 1108, e.g., a connector, which can be coupled to one or more antennas 1120 that are external to the electronic device 1100. Thus, electronic device 1100 may or may not include the one or more antennas 1120. Networking subsystem 1114 includes at least a networking system based on the standards described in IEEE 802.11 (e.g., a WiFi networking system).

Networking subsystem 1114 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 1100 may use the mechanisms in networking subsystem 1114 for performing simple wireless communication between the electronic devices, e.g., transmitting frames and/or scanning for frames transmitted by other electronic devices.

Processing subsystem 1110, memory subsystem 1112, and networking subsystem 1114 are coupled together using bus 1128. Bus 1128 may include an electrical, optical, and/or electro-optical connection that the subsystems can use to communicate commands and data among one another.

Electronic device 1100 can be (or can be included in) any electronic device with at least one network interface. For example, electronic device 1100 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

The operations performed in the communication techniques according to embodiments of the present disclosure may be implemented in hardware or software, and in a wide variety of configurations and architectures. For example, at least some of the operations in the communication techniques may be implemented using program instructions 1122, operating system 1124 (such as a driver for interface circuit 1118) or in firmware in interface circuit 1118. Alternatively or additionally, at least some of the operations in the communication techniques may be implemented in a physical layer, such as hardware in interface circuit 1118.

Embodiments of the present disclosure have been described above with reference to the accompanying drawings, in which embodiments of the disclosure are shown. The inventive concepts may, however, be embodied in many different forms and should not be construed as limited to the embodiments set forth herein. Rather, these embodiments are provided so that this disclosure will be thorough and complete, and will fully convey the scope of the disclosure to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

What is claimed is:

1. A geolocation beacon, comprising:
a processor;
a positioning signal reception system; and
a wireless signal transmission system,
wherein the processor is configured to identify a geolocation of the geolocation beacon using positioning signals received by the positioning signal reception system and transmit the geolocation using the wireless signal transmission system.

2. The geolocation beacon of claim 1, wherein the wireless signal transmission system comprises a WiFi-enabled antenna.

3. The geolocation beacon of claim 1, wherein the wireless signal transmission system comprises a Bluetooth-enabled antenna.

4. The geolocation beacon of claim 3, wherein the wireless signal transmission system comprises a Bluetooth Low Energy (BLE) beacon.

5. The geolocation beacon of claim 1, wherein the processor is further configured to transmit an uncertainty value of the geolocation using the wireless signal transmission system.

6. The geolocation beacon of claim 1, wherein the processor is further configured to generate encryption credentials and encrypt the geolocation prior to the transmitting of the geolocation using the wireless signal transmission system.

7. The geolocation beacon of claim 1, wherein the processor is further configured transmit the geolocation using the wireless signal transmission system periodically.

8. An access point configured to provide wireless network service for a coverage area, the access point comprising a processor configured to:
attempt to obtain a geolocation signal transmitted wirelessly from a geolocation beacon;
detect that the geolocation signal was not obtained from the geolocation beacon;
obtain a geolocation from a controller configured to control at least some operations of the access point;
provide the obtained geolocation to an Automated Frequency Coordination (AFC) server;
receive approval from the AFC server to enter a standard power mode; and
enter the standard power mode.

9. The access point of claim 8, wherein the access point is a first access point, and wherein the geolocation that is obtained from the controller is based on the geolocation signal being received from the geolocation beacon by a second access point.

10. The access point of claim 9, wherein the first access point is configured to calculate an offset value comprising a first approximated distance between the geolocation beacon and the second access point and a second approximated distance between the second access point and the first access point.

11. The access point of claim 8, wherein the processor is configured to instantiate a watchdog timer and is configured to reattempt obtaining a geolocation signal transmitted wirelessly from the geolocation beacon upon expiration of the watchdog timer.

12. An access point configured to provide wireless network service for a coverage area, the access point comprising a processor configured to:
receive an access credential;
obtain an encrypted geolocation signal transmitted wirelessly from a geolocation beacon;
decrypt the encrypted geolocation signal and obtain a geolocation from the decrypted geolocation signal; and
provide the obtained geolocation to an Automated Frequency Coordination (AFC) server.

13. The access point of claim 12, wherein the processor is further configured to receive a decision from the AFC server indicating whether the access point may enter a standard power mode.

14. The access point of claim 12, wherein the processor is further configured to transmit the obtained geolocation to a controller that controls at least some operations of the access point.

15. The access point of claim 12, wherein the processor is further configured to transmit the encrypted geolocation signal to a controller that controls at least some operations of the access point.

16. The access point of claim 12, wherein the access point comprises a WiFi-enabled antenna configured to receive the encrypted geolocation signal.

17. The access point of claim 12, wherein the access point comprises a Bluetooth-enabled antenna configured to receive the encrypted geolocation signal.

18. The access point of claim 12, wherein the access point is an indoor or outdoor access point.

19. The access point of claim 12, wherein the access point is configured to calculate an offset value comprising an approximated distance between the geolocation beacon and the access point.

20. The access point of claim 12, wherein the access point is configured to obtain the encrypted geolocation signal transmitted wirelessly from the geolocation beacon during an initialization or start-up process.
